(19) United States
(12) Patent Application Publication
(10) Pub. No.: US 2026/0036064 A1
(43) Pub. Date: Feb. 5, 2026

(54) CRUSHABLE BEARING RING FOR A FAN ASSEMBLY

(71) Applicant: General Electric Company, Schenectady, NY (US)

(72) Inventors: Nicholas Joseph Kray, Mason, OH (US); Daniel Edward Mollmann, Cincinnati, OH (US); Nicholas M. Daggett, Camden, ME (US); Arthur William Sibbach, Boxford, MA (US)

(21) Appl. No.: 18/794,384

(22) Filed: Aug. 5, 2024

(51) Int. Cl. F01D 21/04; F01D 5/14; F01D 25/24

(52) U.S. Cl. CPC F01D 21/045; F01D 5/147; F01D 25/24; F05D 2220/36; F05D 2240/50; F05D 2250/283; F05D 2300/505

(57) ABSTRACT

A gas turbine engine is provided. The gas turbine engine includes: a fan blade and a trunnion. The trunnion defines a longitudinal direction and a transverse direction. The fan blade is coupled to the trunnion. The gas turbine engine further includes a disk. The trunnion is coupled to the disk and defines a load path from the trunnion to the disk. The gas turbine engine further includes a crushable bearing ring positioned between the trunnion and the disk along the defined load path.

### FIELD

The present disclosure relates generally to a feature of a fan assembly for a gas turbine engine.

### BACKGROUND

A gas turbine engine generally includes a fan section and a turbomachine arranged in flow communication with one another. The turbomachine of the gas turbine engine generally includes, in serial flow order, a compressor section, a combustion section, a turbine section, and an exhaust section. In operation, an airflow is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the combustion section drives the combustion section and is then routed through the exhaust section, e.g., to atmosphere. In particular configurations, the turbine section is mechanically coupled to the compressor section by a shaft extending along an axial direction of the gas turbine engine.

The fan section includes a fan assembly having a plurality of fan blades. The plurality of fan blades is typically driven by the shaft. Each fan blade in the plurality of blades can be attached to a trunnion, the trunnion in turn attached to a disk making up the variable pitch fan assembly. The trunnion is rotatable relative to the disk to allow for varying pitch of the plurality of fan blades. Accordingly, the trunnion may be attached to the disk using various bearings and other accompanying structures. Improvements to trunnion mechanisms would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is schematic cross-sectional view of a gas turbine engine having an unducted fan according to an embodiment of the present disclosure.

FIG. 2 is perspective view of a variable pitch fan of a gas turbine engine in accordance with an embodiment of the present disclosure.

FIG. 3 is a schematic cross-sectional view of a variable pitch fan assembly, particularly illustrating a trunnion, a disk, and a first and second crushable bearing ring in accordance with an embodiment of the present disclosure.

FIG. 4 is a side view of a crushable bearing ring in accordance with an embodiment of the present disclosure.

FIG. 5A is a top view of a crushable bearing ring in accordance with an embodiment of the present disclosure, with the crushable bearing ring in an uncrushed state.

FIG. 5B is a top view of the exemplary crushable bearing ring of FIG. 4A, with the crushable bearing ring in an embodiment state.

FIG. 6A is a top view of a crushable bearing ring, particularly illustrating crushable media with a corrugated design in accordance with an embodiment of the present disclosure, with the crushable bearing ring in an uncrushed state.

FIG. 6B is a top view of a crushable bearing ring, particularly illustrating crushable media with a corrugated design in accordance with an embodiment of the present disclosure, with the crushable bearing ring in an uncrushed state.

FIG. 7 is an axial view of the crushable bearing ring shown in FIG. 6 along line A-A, depicting a three-coil embodiment of the present disclosure.

FIG. 8 is an axial view of the crushable bearing ring shown in FIG. 6 along line A-A, depicting a six-coil embodiment of the present disclosure.

Repeat use of reference characters in the present specification and drawings is intended to represent the same or analogous features or elements of the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines as may be used in the present disclosure include open rotor engines, turbofan engines, and/or turboprop engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The terms “forward” and “aft” refer to relative positions to body of the aircraft. For example, with regard to a gas turbine engine, forward refers to a position closer to the front of the aircraft and aft refers to a position closer to the tail of the aircraft.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first”, “second”, and “third” may be used interchangeably to distinguish one component from another and are not intended to signify location or importance of the individual components.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “integral”, “unitary”, or “monolithic” as used to describe a structure refers to the structure being formed integrally of a continuous material or group of materials with no seams, connections joints, or the like. The integral, unitary structures described herein may be formed through additive manufacturing to have the described structure, or alternatively through a casting process, etc.

The term “shape memory alloy material” and “shape memory alloy (SMA)” generally refer to a metal alloy that experiences a temperature-related or strain-related, solid-state, micro-structural phase change. An SMA material may change from one physical shape to another physical shape. The temperature at which a phase change occurs generally is called the critical or transition temperature of the SMA. The SMA material may be constructed of a single SMA or of various SMA materials. In an embodiment, high temperature SMA may define transition temperatures ranging between about 20 degrees Celsius and about 1400 degrees Celsius. The transition temperature of the SMA may be tunable to specific applications.

A SMA material is generally an alloy capable of returning to its original shape after being deformed. For instance, SMA materials may define a hysteresis effect where the loading path on a stress-strain graph is distinct from the unloading path on the stress-strain graph. Thus, SMA materials may provide improved hysteresis damping as compared to traditional elastic materials.

A SMA material may also provide varying stiffness, in a pre-determined manner, in response to certain ranges of temperatures. The change in stiffness of the shape memory alloy may be due to a temperature related, solid state micro-structural phase change that enables the alloy to change from one physical shape to another physical shape. The changes in stiffness of the SMA material may be developed by working and annealing a preform of the alloy at or above a temperature at which the solid state micro-structural phase change of the shape memory alloy occurs. Such may allow a component formed of a SMA to act as a spring extension having a desired stiffness profile.

In the manufacture of a component comprising SMA (also referred to as an SMA component) intended to change stiffness during operation of a gas turbine engine, the component may be formed to have one operative stiffness (e.g., a first stiffness) below a transition temperature and have another stiffness (e.g., a second stiffness) at or above the transition temperature.

Non-limiting examples of SMAs that may be suitable for forming various embodiments of the SMA components described herein may include nickel-titanium (NiTi) and other nickel-titanium based alloys such as nickel-titanium hydrogen fluoride (NiTiHf) and nickel-titanium palladium (NiTiPd). However, it should be appreciated that other SMA materials may be equally applicable to the current disclosure. For instance, in certain embodiments, the SMA material may include a nickel-aluminum based alloys, copper-aluminum-nickel alloy, or alloys containing zinc, zirconium, copper, gold, platinum, and/or iron. The alloy composition may be selected to provide the desired stiffness effect for the application such as, but not limited to, damping ability, transformation temperature and strain, the strain hysteresis, yield strength (of martensite and austenite phases), resistance to oxidation and hot corrosion, ability to change shape through repeated cycles, capability to exhibit one-way or two-way shape memory effect, and/or a number of other engineering design criteria. Suitable shape memory alloy compositions that may be employed with the embodiments of present disclosure may include, but are not limited to NiTi, NiTiHf, NiTiPt, NiTiPd, NiTiCu, NiTiNb, NiTiVd, TiNb, CuAlBe, CuZnAl and some ferrous based alloys. In some embodiments, NiTi alloys having transition temperatures between 5° C. and 150° C. are used. NiTi alloys may change from austenite to martensite upon cooling.

Moreover, SMA materials may also display superelasticity. Superelasticity may generally be characterized by recovery of large strains, potentially with some dissipation. For instance, martensite and austenite phases of the SMA material may respond to mechanical stress as well as temperature induced phase transformations. For example, SMAs may be loaded in an austenite phase (i.e. above a certain temperature). As such, the material may begin to transform into the (twinned) martensite phase when a critical stress is reached. Upon continued loading and assuming isothermal conditions, the (twinned) martensite may begin to detwin, allowing the material to undergo plastic deformation. If the unloading happens before plasticity, the martensite may generally transform back to austenite, and the material may recover its original shape by developing a hysteresis.

The term “bimetallic material” refers to a material having a first layer formed of a first material and a second layer formed of a second material, with the first and second materials configured to expand differently in response to temperature, strain, or a combination thereof. For example, the first material may define a first coefficient of thermal expansion and the second material may define a second coefficient of thermal expansion different than the first coefficient of thermal expansion. Additionally or alternatively one of the first material or the second material may be a SMA material configured to expand differently than the other of the first material or the second material in response to operating conditions to which the bimetallic material is expected to be exposed.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Generally, a gas turbine engine includes a fan and a turbomachine, with the turbomachine rotating the fan to generate thrust. The turbomachine includes a compressor section, a combustion section, a turbine section, and an exhaust section and defines a working gas flowpath therethrough. The present disclosure is generally related to a fan assembly of a gas turbine engine having a crushable bearing ring and a gas turbine engine including the same. As used herein, the term “crushable” in the context of a crushable bearing ring refers to a bearing ring including a crushable media along a load path of the bearing ring. Further, it will be appreciated, that as used herein, the term “crushable media” refers to any structure that is capable of withstanding anticipated loads during normal operating conditions of the variable pitch fan assembly, but that is designed to fail (e.g., crush and absorb forces) during an extreme load condition prior to the surrounding structure. The crushable media may be a foam material that may only be compressed in response to an extreme load condition, or may be a material capable of compressing on one side and expanding on an opposite side in response to the extreme load condition. For example, the material may be a honeycomb structure capable of compressing on one side and expanding on an opposite side.

In certain engine architectures, the fan assembly includes a fan having a plurality of fan blades and a disk, with the fan blades attached to the disk through a respective plurality of trunnions. The fan assembly can be a variable pitch fan assembly including a plurality of bearings to achieve a desired fan blade pitch change. This bearing/attachment system is designed for certain loading conditions as well as extreme loading conditions, e.g., bird ingestion, and includes a crushable bearing ring surrounding the bearings of the trunnion. More specifically, as used herein, extreme load conditions refers to conditions outside of normal operating conditions (e.g., cruise, takeoff, climb) which can cause damage to the trunnion assembly, potentially resulting in the impairment of the assembly and difficulty in the continued rotation of the fan blades into a desired pitch. As noted above, one example of an extreme load condition is a bird ingestion event.

In particular, the fan assembly includes a fan blade, a disk, and a trunnion having a trunnion, a bearing, a hub, and a crushable bearing ring. The trunnion extends at least partially through the disk, and is connected to the disk across the bearing, forming a load path from the trunnion to the disk. In at least some embodiments, the crushable bearing rings surround the outside of the bearings, positioned along the load path defined by the trunnion and the disk. The crushable bearing ring includes a crushable media and a casing, with the crushable media positioned within the casing of the crushable bearing ring.

Under extreme load conditions, damage can be incurred by the trunnion and variable pitch fan assembly. In particular, the damage to the trunnion can prevent the variable pitch fan assembly from adjusting a pitch of the fan. This may result in the airfoil producing undesirable aerodynamic resistance.

The present disclosure provides a crushable bearing ring that may absorbs some of the forces imposed upon the trunnion and disk when the fan assembly encounters extreme load conditions. Upon the occurrence of an extreme load event, the crushable bearing ring can crush in the direction of the force load, flattening on one side and potentially extending in the other to stabilize the bearing. This may allow for continued functionality of the trunnion following the extreme load conditions, allowing the fan assembly to continue to rotate.

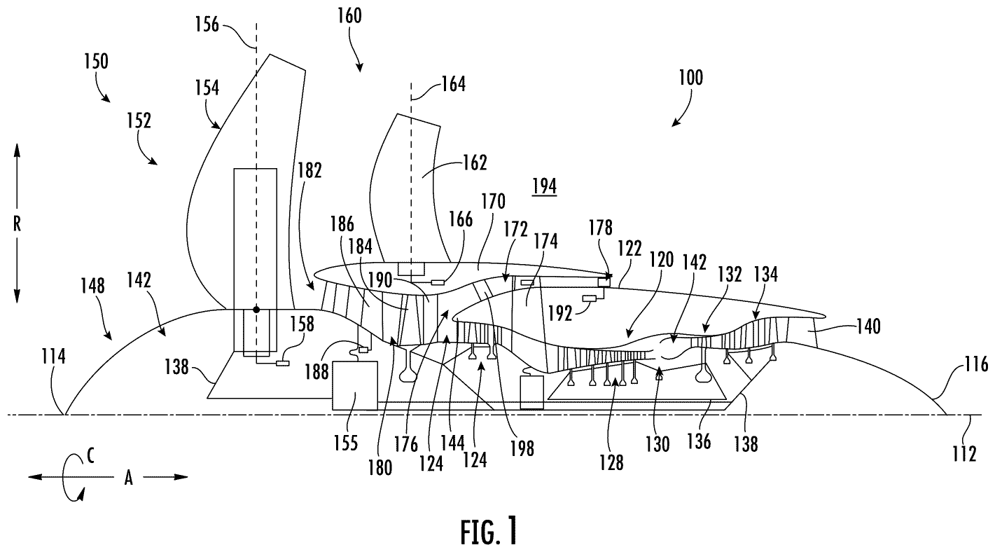

Referring now to the drawings, wherein identical numerals indicate the same elements throughout the figures, FIG. 1 is a schematic cross-sectional view of a gas turbine engine 100 in accordance with an embodiment of the present disclosure. Particularly, FIG. 1 provides a gas turbine engine having a rotor assembly with a single stage of unducted rotor blades. In such a manner, the rotor assembly may be referred to herein as an “unducted fan,” or the entire engine 100 may be referred to as an open rotor engine. In addition, the engine 100 of FIG. 1 includes a third stream extending from the compressor section to a rotor assembly flow path over the turbomachine, as will be explained in more detail below.

For reference, the engine 100 defines an axial direction A, a radial direction R, and a circumferential direction C. Moreover, the engine 100 defines an axial centerline 112 that extends along the axial direction A. In general, the axial direction A extends parallel to the axial centerline 112, the radial direction R extends outward from and inward to the axial centerline 112 in a direction orthogonal to the axial direction A, and the circumferential direction extends three hundred sixty degrees (360°) around the axial centerline 112. The engine 100 extends between a forward end 114 and an aft end 116, e.g., along the axial direction A.

The engine 100 includes a fan section 150 and a turbomachine 120 located downstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems and are not meant to imply any absolute speed or pressure values.

The high energy combustion products flow from the combustor 130 downstream to an HP turbine 132. The HP turbine 132 drives the HP compressor 128 through a high pressure shaft 136. In this regard, the HP turbine 132 is drivingly coupled with the HP compressor 128. The high energy combustion products then flow to an LP turbine 134. The LP turbine 134 drives the LP compressor 126 and components of the fan section 150 through an LP shaft 138. In this regard, the LP turbine 134 is drivingly coupled with the LP compressor 126 and components of the fan section 150. The LP shaft 138 is coaxial with the HP shaft 136 in this example embodiment. After driving each of the HP and LP turbines 132, 134, the combustion products exit the turbomachine 120 through a turbomachine exhaust nozzle 140.

Accordingly, the turbomachine 120 defines a working gas flow path or core duct 146 that extends between the core inlet 124 and the turbomachine exhaust nozzle 140. The core duct 146 is an annular duct positioned generally inward of the core cowl 122 along the radial direction R. The core duct 146 (e.g., the working gas flow path through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the engine 100 may be referred to as an open rotor engine.

As depicted, the fan 152 includes an array of fan blades 154 (only one shown in FIG. 1). The fan blades 154 are rotatable, e.g., about the axial centerline 112. As noted above, the fan 152 is drivingly coupled with the LP turbine 134 via the LP shaft 138. For the embodiments shown in FIG. 1, the fan 152 is coupled with the LP shaft 138 via a speed reduction gearbox 155, e.g., in an indirect-drive or geared-drive configuration.

It will be appreciated that the fan blades 154 may be configured to be composite fan blades, e.g., formed in whole or in part of a composite material. The term composite material as used herein may be defined as a material containing a reinforcement such as fibers or particles supported in a binder or matrix material. Composites include metallic and non-metallic composites.

Moreover, the array of fan blades 154 can be arranged in equal spacing around the axial centerline 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 1) disposed around the axial centerline 112. For this embodiment, the fan guide vanes 162 are not rotatable about the axial centerline 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 158 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the axial centerline 112) as the fan blade 154. The ducted fan 184 is, for the embodiment depicted, driven by the low pressure turbine 134 (e.g., coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1) arranged in a single stage, such that the ducted fan 184 may be referred to as a single stage fan. The fan blades of the ducted fan 184 can be arranged in equal spacing around the axial centerline 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flow path, or simply a fan duct 172. According to this embodiment, the fan flow path or fan duct 172 may be understood as forming at least a portion of the third stream of the engine 100.

Incoming air may enter through the fan duct 172, through a fan duct inlet 176, and may exit through a fan exhaust nozzle 178 to produce propulsive thrust. The fan duct 172 is an annular duct positioned generally outward of the core duct 146 along the radial direction R. The fan cowl 170 and the core cowl 122 are connected together and supported by a plurality of substantially radially extending, circumferentially spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 or core cowl 122. In many embodiments, the fan duct 172 and the core duct 146 may at least partially co-extend (generally axially) on opposite sides (e.g., opposite radial sides) of the core cowl 122. For example, the fan duct 172 and the core duct 146 may each extend directly from a leading edge 144 of the core cowl 122 and may partially co-extend generally axially on opposite radial sides of the core cowl 122.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 146 and the fan duct 172 by a fan duct splitter or leading edge 44 of the core cowl 122. In the embodiment depicted, the inlet duct 180 is wider than the core duct 146 along the radial direction R. The inlet duct 180 is also wider than the fan duct 172 along the radial direction R.

Notably, for the embodiment depicted, the engine 100 further includes an array of inlet guide vanes 186 positioned in the inlet duct 180 upstream of the ducted fan 184 and downstream of the engine inlet 182. The array of inlet guide vanes 186 are arranged around the axial centerline 112. For this embodiment, the inlet guide vanes 186 are not rotatable about the axial centerline 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 158 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes (OGVs) 190. As with the array of inlet guide vanes 186, the array of outlet guide vanes 190 are not rotatable about the axial centerline 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 158 for modulating the variable geometry exhaust nozzle. For example, the variable geometry exhaust nozzle may be configured to vary a total cross-sectional area (e.g., an area of the nozzle in a plane perpendicular to the axial centerline 112) to modulate an amount of thrust generated based on one or more engine operating conditions (e.g., temperature, pressure, mass flowrate, etc. of an airflow through the fan duct 172). A fixed geometry exhaust nozzle may also be adopted.

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 194 may be positioned in thermal communication with the fan duct 172. For example, one or more heat exchangers 194 may be disposed within the fan duct 172 and utilized to cool one or more fluids from the core engine with the air passing through the fan duct 172, as a resource for removing heat from a fluid, e.g., compressor bleed air, oil, or fuel.

Although not depicted, the heat exchanger 194 may be an annular heat exchanger extending substantially 360 degrees in the fan duct 172 (e.g., at least 300 degrees, such as at least 330 degrees). In such a manner, the heat exchanger 194 may effectively utilize the air passing through the fan duct 172 to cool one or more systems of the engine 100 (e.g., lubrication oil systems, compressor bleed air, electrical components, etc.). The heat exchanger 194 uses the air passing through the fan duct 172 as a heat sink and correspondingly increases the temperature of the air downstream of the heat exchanger 194 exiting the fan exhaust nozzle 178.

It should be appreciated that the engine 100 depicted in FIG. 1 and described herein is by way of example only, and that embodiments of the present disclosure may be incorporated in other gas turbine engines as well (such as a ducted turbofan engines).

It will be appreciated, however, that the exemplary engine 100 is provided by way of example only. In other exemplary embodiments, the engine 100 may have any other configuration. For example, in other exemplary embodiments, the turbomachine 120 may have any other number and arrangement of shafts, spools, compressors, turbines, etc. Further, in other exemplary embodiments, the engine 100 may alternatively be configured as a ducted turbofan engine (including an outer nacelle surrounding the fan 152 and a portion of the turbomachine 120); as a direct drive gas turbine engine (may not include a reduction gearbox, such as gearbox 155); as a two-stream gas turbine engine (may not include the duct 172); etc.

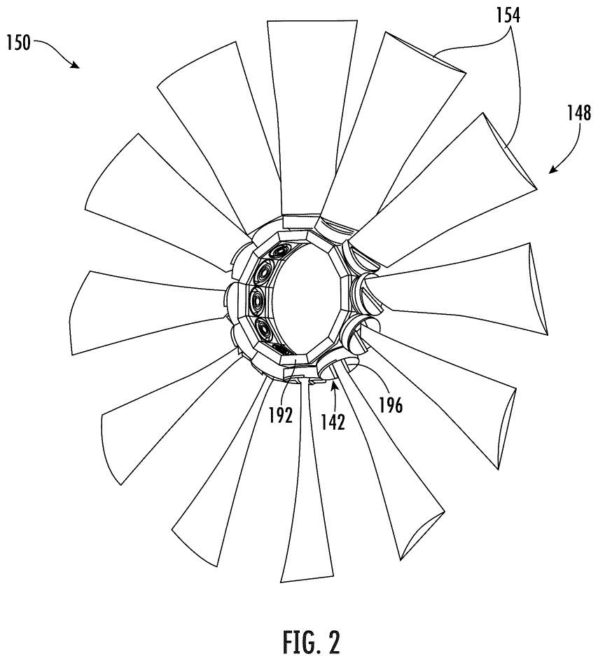

Referring now to FIG. 2, providing a perspective view of a portion of the fan section 150 of the engine 100 of FIG. 1, it will be appreciated that the fan section 150 includes a variable pitch fan assembly 148 and a disk 142 having a plurality of disk segments 192 arranged a spaced apart manner (i.e., spaced along the circumferential direction C; see FIG. 2). The variable pitch fan assembly 148 is coupled to the disk 142, comprising trunnion 196 coupled to the disk 142 and the fan blade 154. The disk 142 has a generally annular shape about the axial direction A. Further, the fan blades 154 extend outwardly from the disk 142 generally along the radial direction R. Each fan blade 154 is also rotatable relative to the disk 142 about central blade axis 156 by virtue of the fan blades 154 being operatively coupled to the actuator(s) 158 (see FIG. 1) configured to collectively vary the pitch of the fan blades 154, e.g., in unison.

Referring particularly to FIG. 2, for the embodiment depicted, the fan assembly 148 includes twelve (12) fan blades 154. From a loading standpoint, such a blade count may allow a span of each fan blade 154 to be reduced such that the overall diameter of the fan assembly 148 may also be reduced (e.g., to about twelve feet in one exemplary embodiment). That said, in other embodiments, the fan assembly 148 may have any suitable blade count and any suitable diameter. In certain suitable embodiments, the fan includes at least eight (8) blades. In another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades.

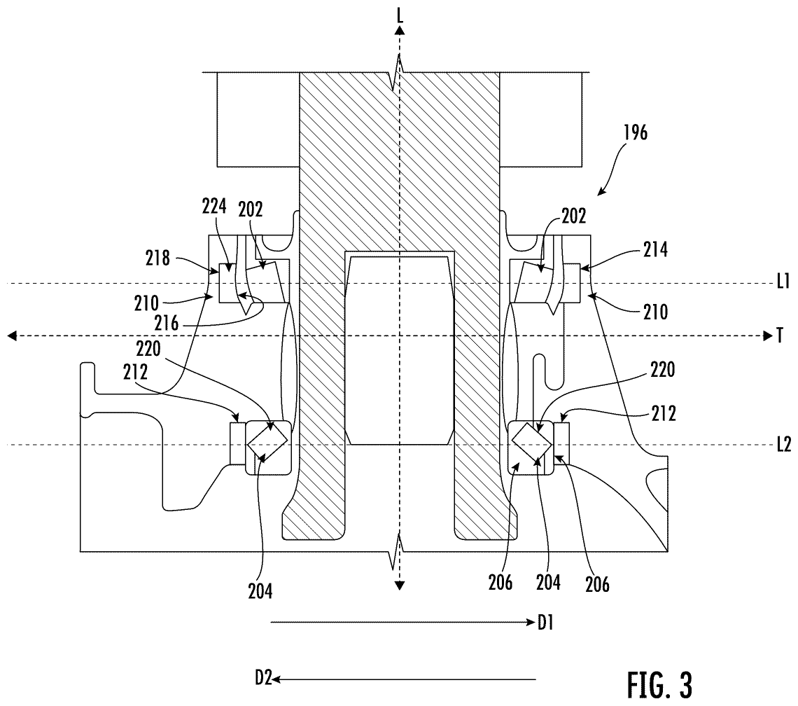

Referring now to FIG. 3, a schematic cross-sectional view of a portion of the exemplary variable pitch fan assembly 148 of FIG. 2 is provided. As will be appreciated, the trunnion 196 defines a longitudinal axis L and a transverse direction T perpendicular to the longitudinal axis L. Further, the variable pitch fan assembly 148 additionally includes a bearing 202 positioned between the trunnion 196 and the disk 142. The trunnion 196 is coupled to disk 142 across the bearing 202. The bearing 202 aids in positioning and supporting trunnion 196 within disk 142, while also allowing for relative motion to occur between trunnion 196 and disk 142 (e.g., to vary a pitch of the fan blade). The bearing 202 includes an inner bearing race 206, an outer bearing race 208, and a plurality of rolling elements 220 therebetween.

As will be appreciated, the variable pitch fan assembly 148 further defines a load path L1 from the trunnion 196 to the disk 142, and more specifically to the disk segment 192. The bearing 202 is positioned along the load path L1, and more specifically, the load path L1 goes through the bearing 202. As used herein, the term “load path,” as it relates to the trunnion 196 and the disk 142, refers to a path along which at least a portion of a total mechanical loads from the trunnion 196 to the disk 142, and/or vice versa, travels.

Referring still to FIG. 3, the variable pitch fan assembly 148 further includes a crushable bearing ring 210 positioned between the trunnion 196 and the disk 142 along the load path L1. The crushable bearing ring 210 includes a casing 214 and crushable media 224 positioned at least partially within the casing 214, as will be discussed in more detail, below. The casing 214 of the crushable bearing ring 210 defines an inner crushable interface 216 and outer crushable interface 218. In the exemplary embodiment depicted, the crushable bearing ring is located outward of the bearing along the transverse direction T. With such a configuration, the inner crushable interface 216 surrounds the bearing 202, e.g., extending 360 degrees around the bearing 202, contacting the outer bearing race 208. The outer crushable interface 218 is surrounded by the disk 142.

Notably, for the exemplary embodiment depicted, the bearing 202 is a first bearing of a plurality of bearings of the variable pitch fan assembly positioned between the trunnion 196 and the disk 142. Similarly, the load path L1 is a first load path of a plurality of load paths from the trunnion 196 to the disk 142, and more specifically to the disk segment 192. In particular, the variable pitch fan assembly 148 includes the first bearing 202 and a second bearing 204, and defines the first load path L1 and a second load path L2. The second bearing 204 may be configured in a similar manner as the first bearing 202 and is, for the embodiment depicted, positioned along the second load path L2. As such, the bearing 204 includes an inner bearing race 206, and outer bearing race 208, and a plurality of rolling elements 220 therebetween.

With such an exemplary aspect, it will further be appreciated that the crushable bearing ring 210 is a first crushable bearing ring 210 of a plurality of crushable bearing rings of the variable pitch fan assembly 148, with each of the plurality of crushable bearing rings being positioned between the trunnion 196 and the disk 142 along one of the plurality of load paths. In particular, the variable pitch fan assembly 148 includes the first crushable bearing ring 210 and a second crushable bearing ring 212. The second crushable bearing ring 212 may be configured in a similar manner as the first crushable bearing ring 210, and further is, for the embodiment depicted, positioned along the second load path L2.

The first bearing 202 is spaced from the second bearing 204 along the longitudinal axis L, and accordingly, the first crushable bearing ring 210 is spaced from the second crushable bearing ring 212 along the longitudinal axis L.

It should be appreciated, however, that the exemplary variable pitch fan assembly 148 depicted in FIG. 3 is by way of example only, and that in other exemplary embodiment, the variable pitch fan assembly 148 may have any other suitable configuration. For example, variable pitch fan assembly 148 may only include at least three and up to five crushable bearing rings 210 placed along various load paths defined by the trunnion 196 and disk 142, each spaced along the longitudinal axis L from one another. Additionally, or alternatively, variable pitch fan assembly 148 may only include one of the crushable bearing ring 210 surrounding one of the first bearing 202 or the second bearing 204.

Referring still to FIG. 3, in certain embodiments, under extreme load conditions, the first crushable bearing ring 210 crushed in a first direction D1. Simultaneously, the second crushable bearing ring 212 is crushed in a second direction D2. The direction D1 and the direction D2 are opposite of one another. In particular, the extreme load condition may be a bird ingestion event, wherein a large force is applied to a fan blade coupled to the trunnion 196. In such a case, the force may be applied in the first direction D1, causing the first crushable bearing ring 210 to crush in the first direction D2 and the second crushable bearing ring 212 to crush in the second direction D2, opposite the first direction D1.

Referring now to FIG. 4, a perspective view of a crushable bearing ring 210 in accordance with an embodiment of the present disclosure is provided. The crushable bearing ring of FIG. 4 includes a casing 214 and a crushable media 224 positioned within the casing 214, and defines a longitudinal axis L and a transverse direction T. Further, the casing 214 defines an inner crushable interface 216 (not shown) and an outer crushable interface 218, forming a cylindrical shape that extends about longitudinal axis L 360 degrees. Additionally, the casing 214 further includes an inner casing segment 232 and an outer casing segment 234 (relative to the longitudinal axis L). The crushable media 224 extends between the inner casing segment 232 to the outer casing segment 234 in a radial direction R.

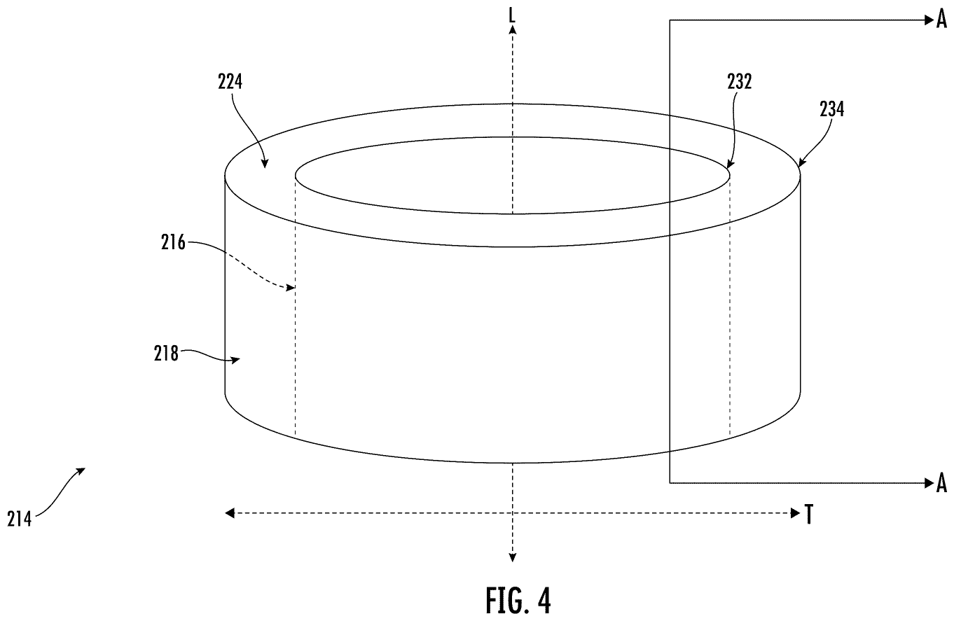

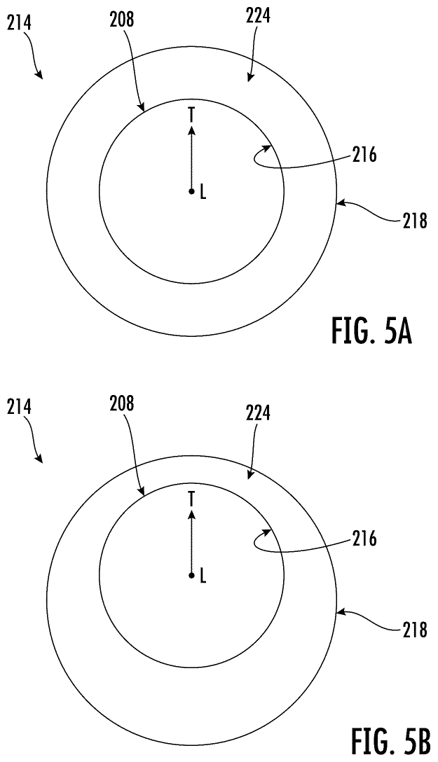

Referring now to FIGS. 5A and 5B, a top-down, schematic view of the crushable bearing ring of FIG. 4 is provided in an uncrushed state (FIG. 5A) and in a crushed state (FIG. 5B). As briefly noted above, the first crushable bearing ring 210 further includes the crushable media 224 positioned at least partially within the casing 214. The crushable media 224 is positioned to reduce the load imposed upon the surrounding structure during extreme load conditions.

As will be appreciated from the views of FIGS. 5A and 5B, during an extreme load condition, the crushable media 224 is configured to absorb forces along the load path L1 to reduce a total force along the load path experienced by, e.g., the trunnion 196, the first bearing 202, and the disk segment 192 (see FIG. 3). For example, in the embodiment of FIGS. 5A and 5B, the crushable media 224 crushes in a transverse direction T (e.g., in a direction of the extreme load) on one side of longitudinal axis L, absorbing the force and reducing the load to the surrounding structure. Further, for the embodiment depicted, the crushable media 224 extends along the transverse direction T (e.g., in a direction opposite the extreme load) on an opposite side of longitudinal axis L to maintain contact with outer bearing race 208 (see FIG. 3).

Such a configuration may allow for the crushable media 224 to absorb at least a portion of the extreme load along the load path to reduce an impact to the surrounding structure in variable pitch fan assembly 148. In this way, the variable pitch fan assembly 148 may continue to function following the extreme load condition.

It will be appreciated, that as used herein, the term “crushable media” refers to any structure that is capable of withstanding anticipated loads during normal operating conditions of the variable pitch fan assembly, but that is designed to fail (e.g., crush and absorb forces) during an extreme load condition prior to the surrounding structure. The crushable media may be a foam material that may only be compressed in response to an extreme load condition, or may be a material capable of compressing on one side and expanding on an opposite side in response to the extreme load condition. For example, the material may be a honeycomb structure capable of compressing on one side and expanding on an opposite side. Further, “crushable media” may be characterized by a deformable force upon the crushable bearing ring and a deformable force on a normal bearing race, a deformable force being the amount of force imparted upon a component to create an inelastic deformation. In the present disclosure, the ratio of deformative force upon a bearing race to that required to deform the crushable material may be at least 1:5, and at most 1:100, depending on the size, weight, blades speed, blade width, etc. of the gas turbine engine.

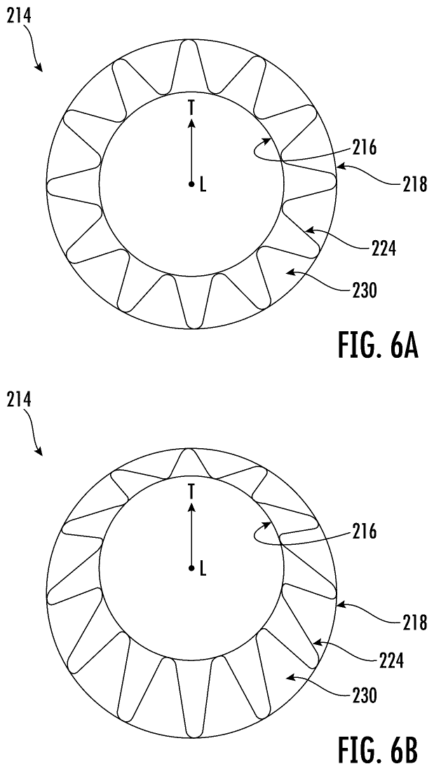

Referring now to FIGS. 6A and 6B, top-down, schematic views of a crushable bearing ring 210 in accordance with another exemplary embodiment of the present disclosure is provided. The exemplary crushable bearing ring 210 of FIGS. 6A and 6B may be configured in substantially the same manner as the first crushable bearing ring 210 of FIGS. 3 through 5B. For example, the crushable bearing ring 210 of FIGS. 5A and 5B generally includes a casing 214 and a crushable media 224 positioned within the casing 214, and defines a longitudinal axis L and a transverse direction T. As with the embodiment above, FIG. 5A depicts the crushable bearing ring prior to an extreme load condition, and FIG. 5B depicts the crushable bearing ring after the extreme load condition.

However, for the exemplary embodiment of FIGS. 5A and 5B, the crushable media 224 is a corrugated structure. During the extreme load condition, the corrugated structure crushes along the transverse direction T (e.g., in a direction of the extreme load) on one side of longitudinal axis L and extends along the transverse direction T (e.g., in a direction opposite the extreme load) of the load on an opposite of longitudinal axis L to maintain contact with an outer bearing race (see, e.g., outer bearing race 208 in FIG. 3).

In the embodiment depicted, the corrugated structure includes a metal band defining a plurality of concave and convex alternatingly arranged about the longitudinal axis L.

It will be appreciated, however, that in other exemplary embodiments, the corrugated structure may have other suitable designs, such as a plurality of metal bands, bands formed of other materials, etc.

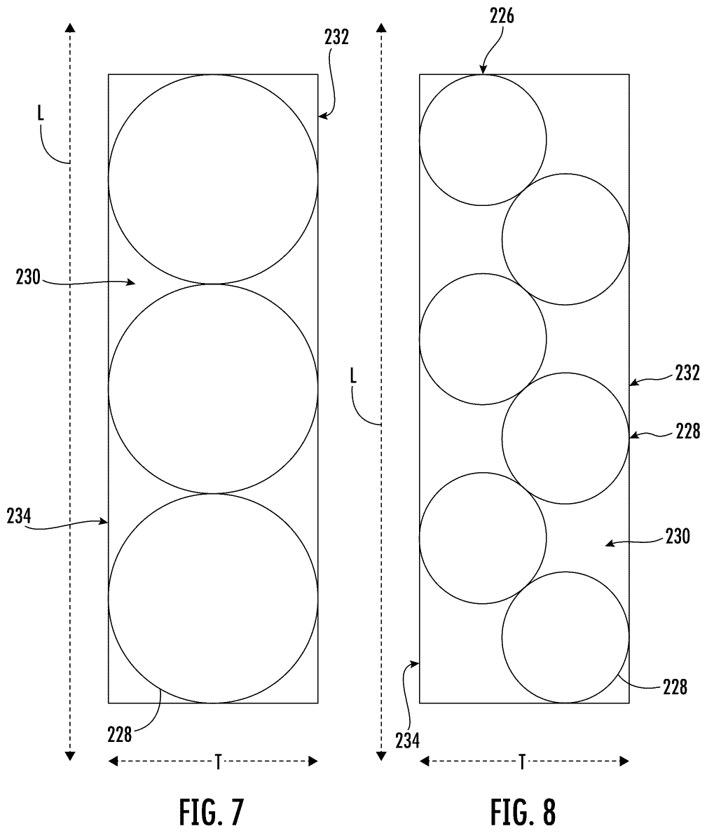

Referring now to FIG. 7, a schematic, axial view of the crushable bearing ring 210 shown in FIG. 4 along line A-A is provided. As noted, the crushable bearing ring includes the crushable media 224. For the exemplary embodiment of FIG. 7, the crushable media 224 includes coil springs 226 that extend about the longitudinal axis L. In particular, the crushable media 224 includes a plurality of coil springs 226, each coil springs defining a diameter. The coil springs 226 each contact opposing walls of the casing along the transverse direction, such that the diameter of each coil spring 226 is equal to a width between the opposing walls of the casing along the transverse direction.

It will be appreciated, however, that in other exemplary embodiments, the coil springs 226 may have any other suitable configuration. For example, referring now to FIG. 8, providing a schematic, axial view of a crushable bearing ring in accordance with another exemplary embodiment of the present disclosure, the crushable bearing ring 210 includes a crushable media 224 having a plurality of coil springs 226, with each coil spring 226 defining a diameter less than a width between opposing walls of a casing of the crushable bearing ring 210 along a transverse direction T. As such, the coils 228 are arranged in an alternating pattern such that one coil 228 contacts the outer casing segment 234, and the next coil 228 is stacked to be in contact with the inner casing segment 232.

In at least certain embodiments, the plurality of coil springs 226 may form one unitary coil spring extending about a longitudinal axis L in a spiral fashion. In other embodiments, the plurality of coil springs 226 may be formed of separate lengths of coil springs and stacked on top of one another.

It will be appreciated, however, that the exemplary crushable media 224 described above with reference to FIGS. 4 through 8 are provided by way of example only. In other exemplary embodiments, a crushable bearing ring 210 may be provided with a crushable media 224 having any suitable configuration, or any suitable combination of configurations. In at least certain exemplary embodiments, the crushable media 224 may have a honeycomb pattern, a corrugated pattern, a coil shape, an additive matrix pattern, or a combination thereof.

Further, the crushable media 224 incorporated may be made of any suitable material, such as aluminum, steel, shape memory alloy, or any suitable combination of materials.

In particular embodiments, crushable bearing ring 210 may further include a polymer 230 (see FIGS. 7 and 8) in which crushable media 224 is at least partially embedded, and at least partially positioned within casing 214. Polymer 230 may be made of any suitable polymer, such as urethane, polyurethane, rubber, or any suitable combination thereof.

Further aspects are provided by the subject matter of the following clauses:

A gas turbine engine comprising: a fan blade; a trunnion defining a longitudinal direction and a transverse direction, the fan blade coupled to the trunnion; a disk, the trunnion coupled to the disk and defining a load path from the trunnion to the disk; and a crushable bearing ring positioned between the trunnion and the disk along the load path.

The gas turbine engine of any of the preceding clauses, wherein the crushable bearing ring comprises; a casing; and a crushable media positioned at least partially within the casing.

The gas turbine engine of any of the preceding clauses, wherein the crushable media defines a honeycomb pattern.

The gas turbine engine of any of the preceding clauses, wherein the crushable media defines a corrugated pattern.

The gas turbine engine of any of the preceding clauses, wherein the crushable media defines a coil shape.

The gas turbine engine of any of the preceding clauses, wherein the crushable media comprises a shape memory alloy.

The gas turbine engine of any of the preceding clauses, wherein the crushable bearing ring further comprises a polymer, and wherein the crushable media is embedded in the polymer.

The gas turbine engine of any of the preceding clauses, wherein the trunnion defines an axis along the longitudinal direction, wherein when the crushable bearing ring is impacted along the transverse direction of the trunnion the crushable media shrinks in the direction of the impact on one side of the axis and extends in the direction of the impact on the opposite side of the axis.

The gas turbine engine of any of the preceding clauses, wherein the crushable bearing ring is a first crushable bearing ring, wherein the load path is a first load path, wherein the disk further defines a second load path from the trunnion to the disk, and wherein the gas turbine engine further comprises: a second crushable bearing ring positioned between the trunnion and the disk along the second load path.

The gas turbine engine of any of the preceding clauses, wherein the first crushable bearing ring is spaced from the second crushable bearing ring along the longitudinal direction of the trunnion.

The gas turbine engine of any of the preceding clauses, the gas turbine engine further comprising: a bearing positioned between the trunnion and the disk, and wherein the crushable bearing ring is located outward of the bearing along the transverse direction.

A connection assembly for a variable pitch fan assembly of a gas turbine engine, the connection assembly comprising: a trunnion defining a longitudinal direction; a disk, the trunnion and disk defining a load path; a first crushable bearing ring located along the load path between the disk and the trunnion; and a second crushable bearing ring along the load path, the second crushable bearing ring spaced from the first crushable bearing ring along the longitudinal direction.

The connection assembly of any of the preceding clauses, wherein first crushable bearing ring comprises a first casing and a first crushable media positioned at least partially within the first casing, and wherein the second crushable bearing ring comprises a second casing and a second crushable media positioned at least partially within the second casing.

The connection assembly of any of the preceding clauses, wherein under extreme load conditions, the first crushable bearing ring is crushed in a first direction, wherein the second crushable bearing ring is crushed in a second direction, wherein the first direction is opposite of the second direction.

The connection assembly of any of the preceding clauses, wherein the first crushable media, the second crushable media, or both defines a corrugated pattern.

The connection assembly of any of the preceding clauses, wherein the first crushable media, the second crushable media, or both defines a honeycomb pattern.

The connection assembly of any of the preceding clauses, wherein the first crushable media, the second crushable media, or both defines a coil shape.

The connection assembly of any of the preceding clauses, wherein the first crushable media, the second crushable media, or both comprises a shape memory alloy.

The connection assembly of any of the preceding clauses, wherein the first crushable media comprises the shape memory alloy, wherein the first crushable bearing ring further comprises a polymer, and wherein the first crushable media is embedded in the polymer.

The connection assembly of any of the preceding clauses, wherein the trunnion defines an axis along the longitudinal direction, wherein when the first crushable bearing ring is impacted along the transverse direction of the trunnion a crushable media of the first crushable bearing ring shrinks in the direction of the impact on one side of the axis and extends in the direction of the impact on the opposite side of the axis.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A gas turbine engine comprising:
a fan blade;
a trunnion defining a longitudinal direction and a transverse direction, the fan blade coupled to the trunnion;
a disk, the trunnion coupled to the disk and defining a load path from the trunnion to the disk;
a bearing positioned between the trunnion and the disk; and
a crushable bearing ring positioned outward of the bearing along the transverse direction between the trunnion and the disk along the load path.

2. The gas turbine engine of claim 1, wherein the crushable bearing ring comprises;
a casing; and
a crushable media positioned at least partially within the casing.

3. The gas turbine engine of claim 2, wherein the crushable media defines a honeycomb pattern.

4. The gas turbine engine of claim 2, wherein the crushable media defines a corrugated pattern.

5. The gas turbine engine of claim 2, wherein the crushable media defines a coil shape.

6. The gas turbine engine of claim 5, wherein the crushable media comprises a shape memory alloy.

7. The gas turbine engine of claim 6, wherein the crushable bearing ring further comprises a polymer, and wherein the crushable media is embedded in the polymer.

8. The gas turbine engine of claim 7, wherein the trunnion defines an axis along the longitudinal direction, wherein when the crushable bearing ring is impacted along the transverse direction of the trunnion the crushable media shrinks in the direction of the impact on one side of the axis and extends in the direction of the impact on the opposite side of the axis.

9. The gas turbine engine of claim 1, wherein the crushable bearing ring is a first crushable bearing ring, wherein the load path is a first load path, wherein the disk further defines a second load path from the trunnion to the disk, and wherein the gas turbine engine further comprises:
a second crushable bearing ring positioned between the trunnion and the disk along the second load path.

10. The gas turbine engine of claim 9, wherein the first crushable bearing ring is spaced from the second crushable bearing ring along the longitudinal direction of the trunnion.

11. The gas turbine engine of claim 1,
wherein the bearing comprises an inner bearing race, and outer bearing race, and a plurality of rolling elements therebetween.

12. A connection assembly for a variable pitch fan assembly of a gas turbine engine, the connection assembly comprising:
a trunnion defining a longitudinal direction and a transverse direction;
a disk, the trunnion and disk defining a load path;
a first bearing positioned between the trunnion and the disk;
a first crushable bearing ring located along the load path between the disk and the trunnion and positioned outward of the bearing along the transverse direction; and
a second crushable bearing ring along the load path, the second crushable bearing ring spaced from the first crushable bearing ring along the longitudinal direction.

13. The connection assembly of claim 12, wherein first crushable bearing ring comprises a first casing and a first crushable media positioned at least partially within the first casing, and wherein the second crushable bearing ring comprises a second casing and a second crushable media positioned at least partially within the second casing.

14. The connection assembly of claim 13, wherein under extreme load conditions, the first crushable bearing ring is crushed in a first direction, wherein the second crushable bearing ring is crushed in a second direction, wherein the first direction is opposite of the second direction.

15. The connection assembly of claim 13, wherein the first crushable media, the second crushable media, or both defines a corrugated pattern.

16. The connection assembly of claim 13, wherein the first crushable media, the second crushable media, or both defines a honeycomb pattern.

17. The connection assembly of claim 13, wherein the first crushable media, the second crushable media, or both defines a coil shape.

18. The connection assembly of claim 13, wherein the first crushable media, the second crushable media, or both comprises a shape memory alloy.

19. The connection assembly of claim 18, wherein the first crushable media comprises the shape memory alloy, wherein the first crushable bearing ring further comprises a polymer, and wherein the first crushable media is embedded in the polymer.

20. The connection assembly of claim 12, wherein the trunnion defines an axis along the longitudinal direction, wherein when the first crushable bearing ring is impacted along the transverse direction of the trunnion a crushable media of the first crushable bearing ring shrinks in the direction of the impact on one side of the axis and extends in the direction of the impact on the opposite side of the axis.
